(19) United States
(12) Patent Application Publication
(10) Pub. No.: US 2026/0184518 A1
(43) Pub. Date: Jul. 2, 2026

(54) INSTALLATION AND METHOD FOR THE HANDLING OF TRAYS

(71) Applicant: SINGULUS TECHNOLOGIES AG, Kahl am Main (DE)

(72) Inventors: Philipp BOZEM, Mömbris (DE); Markus HEIDRICH, Hanau (DE); Wolfgang BECKER, Schaafheim (DE)

(21) Appl. No.: 19/130,495

(22) PCT Filed: Nov. 6, 2023
(86) PCT No.: PCT/EP2023/080758

§ 371 Date: May 15, 2025

(30) Foreign Application Priority Data
Dec. 12, 2022 (DE) 10 2022 132 969.0

(51) Int. Cl. B65G 59/02

(52) U.S. Cl. CPC B65G 59/02; B65G 2201/0258

(57) ABSTRACT

System comprising a supply zone, a first and a second output zone, each comprising. an output handling device, at least a first waiting zone, a transfer zone comprising a manipulator, at least one tray picking handling device and two tray carriages. The at least one tray picking handling device is adapted to remove at least two tray units from a stack of a plurality of tray units at the same time and to move the removed tray units from the supply zone to a first waiting position in the first waiting zone and/or the two tray carriages can be moved on vertically offset paths.

The present invention relates to a system or a system module having an output handling device. In particular, the invention relates to a system or a system module having an output handling device which is adapted to remove products from a tray, wherein the tray can be used in wet chemical production processes, in particular in production processes for contact lenses.

A known method for the production of contact lenses comprises, in a first step, the production of so-called moulds in an injection moulding process. The actual contact lenses are then produced in these moulds. As a rule, after curing of the lenses, a process step for post-processing or cleaning the contact lenses is required, in which, among others, incompletely polymerized polymer residues are extracted before the contact lenses can be individually tested and packaged.

The contact lenses can be produced in the moulds in one or more batches. As a rule, the subsequent cleaning and surface treatment is carried out in a wet chemical process system containing several process tanks filled with liquid in which the contact lenses are immersed for cleaning and surface treatment. Contact lenses consist, in particular, of optical substrates made of polymer or monomer components which are subjected to one or more wet chemical processes such as cleaning, etching and deposition during the cleaning and surface treatment process. In order for the contact lenses to be treated with high productivity (in particular with regard to processing time and/or production output) in a wet chemical process system, it is customary to convey the contact lenses through the wet chemical process system on product carriers, so-called transport trays, or trays (for short). In this context, it is generally important that the contact lenses are released individually on a tray or that a plurality of contact lenses are spatially separated from one another on a tray. For this reason, trays are usually used which, for example, comprise a plurality of recesses/wells in one plane so that a contact lens can be released in each well. In view of an economic realization of the wet chemical processes usually a plurality of stacked trays, so-called stacks, are conveyed together through the wet chemical process system and, thus, a stack of trays is treated simultaneously in each process tank. As a rule, every top tray of a stack is covered with a tray cover. The tray cover is a cover for the last tray loaded with contact lenses so that the contact lenses remain in the wells and are not washed out of the wells during treatment. In the trays underneath, the subsequent tray forms the cover. After the contact lenses in their trays passed through the wet chemical process system, it is necessary to remove the contact lenses again individually from the trays to subsequently process them further, for example check them or package them separately. In known processing systems, output handling devices are used to this aim.

For example, continuous systems are known that comprise a wet chemical process module with a plurality of process tanks and an output module comprising an output handling device. The output handling device comprises a plurality of suction devices adapted to remove contact lenses from a tray by suction after they passed the process tanks.

The production of contact lenses is subject to strict quality standards. In particular, it should be noted that contact lenses should be exposed to ambient air only for a limited time span during the production process und that, in addition, only a limited time window is available between the time of their production in the moulds and the packaging of the finished contact lenses in disposable airtight packaging.

The number of contact lenses that can be produced in a given period of time in a production system is limited by the throughput times of the individual process steps in the production process, in particular by the injection moulding process and by the time required for removal of the individual contact lenses from the trays.

The output of a production system can be increased by using more or more powerful injection moulding machines and by adjusting the capacity of the output handling device accordingly. This is why, in some production facilities, multiple injection moulding machines are used and, accordingly, contact lenses are produced in multiple batches (the production of each injection moulding machine is assigned to a separate batch). Thus, the production output can be easily regulated by switching individual units on and off.

In any case, however, if production is carried out in several batches, further processing of the contact lenses has to be carried out separately according to the individual batches (i.e. separately for each individual batch) in order to allow for unambiguous traceability and to meet the high quality standards of the industry. In addition, consistent quality of the contact lenses produced requires that each contact lens passes through each process step in approximately the same time.

This implies high requirements with respect to the wet chemical cleaning process, including the removal of the contact lenses from the trays, since the lenses from multiple batches have to be processed according to the first-in-first-out principle (FIFO principle) on the one hand in order to adhere to a limited and approximately constant production time window, and to ensure further processing in individual batches on the other hand.

From the prior art, only facilities having one single output handling device are known. With these systems, it is not possible to implement separate processing in accordance with individual batches (i.e. batchwise processing) for a plurality of batches. If the number of output handling devices is to be adjusted to the number of batches in a known system, procedural disadvantages will arise since first of all, it is not possible to simply adhere to the FIFO principle if the batches are processed separately; in addition, it cannot be ensured that maximum throughput times for contact lenses are observed across batches as required and finally, there is no known automatic tray cover handling, with the cover usually released on top of each stack, which would not repeatedly block individual output handling devices during the operation of the system, thereby reducing the productivity of a corresponding system module.

Thus, there is a need for a system or a system module which is able to process or realize contact lenses separately in accordance with individual batches (i.e. batchwise) and in accordance with the FIFO principle and which can preferably remove the contact lenses after they passed through the wet chemical process module from the tray, while processing in accordance with individual batches and in accordance with the FIFO principle, preferably avoiding cross-contamination and, in addition, preferably putting not only the contact lenses but also the trays through the system or the system module in accordance with the FIFO principle.

This need cannot be met by the prior art, since known systems are not able to process or to put through contact lenses and/or trays from multiple batches batchwise and in accordance with the FIFO principle.

Thus, an object of the present invention is to provide a system or system module which can meet the identified need at least partially and/or compensate the disadvantages described above at least partially. In other words, in the context of the present invention, a system is to be realized which is able to empty the trays from different batches, with the individual trays containing solely contact lenses from one respective batch, in accordance with the FIFO principle. For this purpose, it is preferred that the contact lenses can be removed from the trays batchwise (i.e. separately in accordance with their respective batch) in accordance with the FIFO principle, and it is further preferred that the trays can be conveyed through the system module in accordance with the FIFO principle.

The present invention solves said problem by a system or system module comprising a supply zone, at least a first and a second output zone, at least a first waiting zone, at least one transfer zone, at least one tray picking handling device and at least two tray carriages.

A supply zone can be the last process tank of a wet chemical system. A process tank can, for example, be filled with an acid (e.g. formic acid), with solvents (e.g. isopropanol), with a base, with distilled water or with mixtures. A supply may also be a tank which is provided in addition to the last process tank of a wet chemical system, which may be filled with a liquid that is preferably only used to store the contact lenses in advantageous environmental conditions.

An output zone can be an area of the system in which the contact lenses can be removed from the trays. For this reason, each output zone comprises at least one output handling device and at least one lifting unit. The output handling device can comprise one or a plurality of devices adapted to remove one or more separate contact lense(s) from a tray. The lifting unit can preferably be disposed with respect to the output handling device in such a way that the latter can position the tray in a vertical direction such that the output handling device can remove the contact lenses. It is further preferred that the lifting unit is adapted to move a tray in a vertical direction between an upper and a lower position, wherein the upper position is a removal position, and the lifting unit does not restrict the movement of the tray carriages, neither in the upper nor in the lower position.

In the context of the disclosure, a waiting zone can be construed as an area in the system in which a tray can be positioned without blocking the supply zone or affect the function of an output handling device in an output zone, preferably an area in which trays can be positioned without affecting the functionality of another area.

A transfer zone can designate an area which can be an interface to an adjacent system, an adjacent system module, to a manual area or to the environment. Each transfer zone comprises at least one manipulator which is adapted to move a tray unit. Preferably, said manipulator can be a tray lift adapted to move a tray unit in the vertical direction and/or to move it to another plane of the system. The system can preferably comprise a transfer zone having a manipulator.

A tray picking handling device can preferably be at least a manipulator adapted to move a tray unit from the supply zone to a waiting zone. Tray picking handling can preferably be realized by means of a manipulator which can be moved in both the horizontal and the vertical direction.

According to a first aspect of the invention, the at least one tray removing handling device is adapted to remove at least two tray units at the same time from a stack of a plurality of tray units and the at least one tray removing handling device is further adapted to move the tray units from the supply zone to a first waiting position in the first waiting zone.

Preferably, the tray removing handling device can further be adapted and configured to deliver or release the at least two picked-up tray units separately and/or deliver or release a first part (a first partial quantity) of the picked-up tray units, with a further part (a further partial quantity) of the picked-up tray units remaining in the tray picking handling device. The partial quantities may preferably be one, two or three and it is further preferred that they are identical or different in size.

According to another aspect of the invention, the at least one tray removing handling device is adapted to remove at least one tray unit from a stack of a plurality of tray units and the at least one tray removing handling device is further adapted to move the at least one tray unit from the supply zone to a first waiting position in the first waiting zone. The at least two tray carriages of the system can preferably be moved along vertically offset paths in a horizontal direction.

In the context of the present disclosure, the terms “horizontal” and “vertical” can be defined as “predominantly” horizontal or vertical. In particular, a horizontal plane or a horizontal direction can have an inclination of maximum 10°, preferably of maximum 5°, more preferably of maximum 2°. A horizontal movement path can be defined as a “predominantly” horizontal movement path. Consequently, a horizontal movement path may have an inclination of maximum 10°, preferably of maximum 5°, further preferred of maximum 2°. In addition, a horizontal movement path can also comprise non-horizontal sections. Preferably, at least 75%, more preferably at least 85% and most preferably at least 95% of a horizontal movement path runs horizontally (or in a plane with an inclination of maximum 10°, preferably of maximum 5°, more preferably of maximum 2° to the horizontal). In particular, the invention comprises a system which extends substantially in the horizontal and/or comprises substantially horizontal and/or substantially linear movement paths, and it is only due to external constraints, for example the space available in a production hall, that the movement paths have sections that are non-horizontal and/or non-linear. It is preferred that these definitions be applied correspondingly to the term “vertical”.

A tray unit can be a tray or a tray cover, preferably a single tray or a single tray cover. Hence, a tray unit can also be referred to as tray object. The at least one tray picking handling device is preferably adapted to move one or more tray units. Particularly preferably, the at least one tray picking handling device is adapted to move an even number of trays or an odd number of trays together with a tray cover. The tray picking handling device can preferably be adapted to move two trays at a time as well as a tray and a tray cover at a time. Depending on the number of batches, the tray picking handling device can be adjusted and be accordingly adapted to move any number of trays, or a tray cover together with the same number of trays minus 1, at the same time, preferably move a number of trays corresponding to the number of batches at the same time, or move a number of trays corresponding to the number of batches minus 1 plus a tray cover at the same time. The tray picking handling device is preferably adapted to disassemble the stack from the top to the bottom and/or remove the topmost tray unit(s) from the stack. The tray picking handling device is further preferably adapted to remove the topmost tray unit(s) from the stack in the supply zone and to convey these into the first waiting zone.

A tray may be an element which is adapted to receive products and to transport these. In particular, the configuration depends on the kind and form of the products for which it is designed and in particular, the way in which said products are to be conveyed through a system. A tray for use in the production of contact lenses can, for example, be a round or angular disk, a tablet or a shallow dish having a top side and a bottom side, with the top side preferably being the side in contact with the product. In the top side, preferably one or a plurality of wells can be formed which are, for example, intended to hold one contact lens each. Preferably, trays can comprise at least 6, more preferably at least 10 and particularly preferably at least 100 wells and the wells and/or the tray can preferably be perforated. The upper side can preferably be approximately rectangular, preferably with rounded corners and have an edge length of at least 100 mm, more preferably of at least 200 mm and particularly preferably of at least 300 mm in the longitudinal direction (length) and at least 50 mm, more preferably at least 100 mm and particularly preferably at least 200 mm in the transverse direction (width). It is further preferred that the top side has a width of maximum 800 mm, more preferably of maximum 600 mm and most preferably of maximum 500 mm wide and a length of maximum 800 mm, more preferably of maximum 600 mm and particularly preferably of maximum 500 mm. Alternatively, the top side can also be round, oval or square. A tray can be subdivided into several smaller inserts or nests, which are enclosed in a frame in such a way that a single tray can be defined which can be conveyed in one piece through a system.

Each tray carriage comprises preferably at least two tray holders, with two tray holders of a first tray carriage preferably having a first distance to one another which corresponds to the distance of the first waiting position to a first lifting unit in the first output zone. It is further preferred that two tray holders of a second tray carriage have a second distance to one another which corresponds to the distance of a second lifting unit in the second output zone and one of the manipulators. Said distances may be particularly advantageous in order to increase the throughput of the system and/or to remove trays from the wet chemical processing area in a particularly time-efficient manner, to empty trays and subsequently convey them into the transfer zone.

It is preferred that at least two tray holders, more preferred that all of the tray holders of a tray carriage are arranged in the same horizontal plane. This allows the manipulator movements to be simplified, implying that complex systems and controls can be reduced or avoided. As a result, the installation space can preferably be reduced and/or kept compact.

It is preferred that the first tray carriage and the second tray carriage, preferably all tray carriages have the same geometry. Thus, it is possible to adhere to a concept of identical parts for all tray carriages, which is advantageous in terms of costs and spare parts stocks. In this context, the geometry can also only relate to functionally relevant core components of the tray carriages which cannot easily be replaced by standard parts or other commonly available standard parts.

The tray picking handling device and/or at least one tray carriage is/are preferably adapted to accommodate trays with a tray width and/or tray length of 200 mm to 800 mm, preferably of 300 mm to 600 mm, particularly preferably of 400 to 500 mm.

Preferably, the system module comprises a second waiting zone which particularly preferably is disposed between the first output zone and the second output zone.

The first lifting unit in the first output zone and the second lifting unit in the second output zone preferably have a distance to one another corresponding at least to the width or length of a tray. Thus, it is possible to ensure that, when providing an output zone with a tray, in particular at a time at which the lifting unit lifts the tray from the tray carriage and under the output handling device, the other output zone is not blocked by a second tray holder of the tray carriage.

It is preferred that the tray carriages can be moved horizontally and the first and/or second output handling device can operate in a horizontal plane that is vertically offset to a movement plane of at least one tray carriage. Thus, the tray carriages can also pass through an output handling device containing trays. This is advantageous in order to operate the system in a time-efficient manner and/or to reduce the susceptibility of the system module to interference and/or to implement a robust system control. In particular, it is possible to transport a tray or tray cover from the supply zone to a second output zone or output station or to a transfer zone while a tray is within the first output zone.

The individual zones can preferably be defined in such a way that they are horizontally adjacent. Thus, the tray carriages can be moved preferably on a simple and direct path between the zones, preferably on horizontal planes, while the output handling devices are arranged vertically offset with respect to the movement paths of the tray carriages. The system could also be constructed with height orientation instead of length orientation. According to one aspect of the invention, the tray carriages could then be moved vertically, while the output handling devices would have to be offset horizontally with respect to the vertical movement paths of the tray carriages.

Preferably, the tray cover can be conveyed by a tray carriage to the transfer zone, it is particularly preferred that the tray cover can be conveyed from the first waiting zone to the transfer zone, without the tray carriage with the tray cover having to stop on the transport path, more preferably without that other systems are blocked.

Preferably, a first stack can be provided in the system in the supply zone and the trays of the first stack can conveyed alternatingly into the first or into the second output zone and/or into the transfer zone. It is further preferred that the tray cover of the first stack is conveyed to the transfer zone, preferably without stopping in an output zone. In other words, it is preferred that the tray cover (i.e. the topmost tray unit) of the first stack can be conveyed into the waiting zone, the topmost tray under the tray cover (i.e. the second tray unit from top) can be conveyed into a first output zone and the second tray from top under the tray cover can be conveyed into the second output zone. Subsequently, the further trays can be conveyed alternately into the first or the second output zone.

Preferably, after the first stack has been disassembled, a second stack can be provided in the supply zone, and the topmost tray under the tray cover of the second stack can be conveyed to the output zone to which the second tray from top under the tray cover of the first stack has been conveyed. It is further preferred that the further trays are conveyed alternately to the two output zones. It is particularly preferred that the tray cover of the second stack can be conveyed to the transfer zone, preferably without stopping in an output zone. In other words, the tray cover (i.e. the topmost tray unit) of the second stack can preferably be conveyed into the transfer zone, the topmost tray under the tray cover (i.e. the second tray unit from top) can be conveyed into the second output zone and the second tray from top under the tray cover can be conveyed into the first output zone. Subsequently, the further trays can be conveyed alternately into the first and the second output zone.

A stack preferably comprises at least 4, more preferably at least 18, most preferably at least 24 tray units and/or a maximum of 80, more preferably a maximum of 70, most preferably a maximum of 50 tray units.

A tray unit has preferably a maximum height of 50 mm, more preferably a maximum of 30 mm, and/or a stack preferably has a maximum height of 1500 mm, more preferably of 1000 mm, more preferably of 720 mm, particularly preferably of 500 mm.

It is preferred that a tray unit and/or a stack can be moved within the system in such a way that the tray height and/or the stack height define(s) a vertical direction of the system. Thus, the trays can be moved horizontally without that the content, i.e. the contact lenses, drop out.

The tray carriage is preferably a linear and/or particularly preferably a horizontally movable transport device. Preferably, the tray carriages can be moved horizontally and/or the movement paths are vertically offset. It is further preferred that the tray carriages and/or the movement paths of the tray carriages are offset by at least one tray height, preferably by at least 30 mm, particularly preferably by at least 50 mm.

Preferably, the tray unit which is located on top of each stack can also be put through the system or the system module first. Consequently, the tray units of the stack can be put through the system or the system module one after another from top to bottom. Consequently, the topmost tray unit arrives at the transfer zone first. For this reason, in order to empty the trays, the system or the system module can operate in accordance with the FIFO principle. In this way, it can be ensured that contact lenses, irrespective of their tray and their position in the tray stack, can be transferred through the system module within a constant period of time. This ensures that each contact lens can be produced with the same process parameters as far as possible, and that consistent quality can be achieved for all contact lenses. Moreover, the FIFO principle ensures that each contact lens is only exposed to the ambient air for a limited time. In addition, the FIFO principle results in the fact that changes in orders or adjustments of the production system to other product types to be produced can be implemented in an orderly and time-efficient manner. In particular, the FIFO principle can be preferably observed for emptying and/or putting through the trays. The tray cover can preferably put through the system or the system module without observing the FIFO principle. In particular, the tray cover, in other words the topmost tray unit of a stack, can preferably be put through the system or the system module, while other trays from a previous stack are still in the first and/or the second output handling device.

The invention further relates to a method for operating a system which is preferably designed according to one or more of the criteria set forth above. The method of the invention comprises one or more of the following steps:
(a) providing tray units stacked to form a stack, wherein a stack comprises at least two tray units and, preferably, the topmost tray unit is a cover and all other tray units are individual trays;
(b) simultaneous removal of at least two tray units from the stack;
(c) separate release of the removed tray units onto at least one conveyor element;
(d) removal of contact lenses from individual trays by means of at least one output handling device.

The terms “simultaneous” or “simultaneously” can preferably be defined in such a way that either term refers to a time interval of less than 3 seconds, preferably less than 1 second, particularly preferably less than 0.1 second.

In particular, a conveyor element can preferably be a horizontal conveyor element, more preferably a tray carriage. Particularly preferably the at least one conveyor element comprises at least two tray carriages and in the disclosed method, it is preferred that a first tray unit removed in step (b) can be released onto a first tray carriage and a second tray unit removed in step (b) can be released on a second tray carriage. In the disclosed method, it is preferred that a first tray carriage and a second tray carriage can be moved horizontally on vertically offset paths. In other words, it is preferred that a first tray carriage can be moved horizontally on a first path and a second tray carriage can be moved horizontally on a second path, with the first path and the second path being vertically offset. Thus, transfer of the contact lenses through the system module can be achieved in accordance with individual batches. Transfer in individual batches can be implemented in a particularly advantageous manner by means of a robust and/or hardly error-prone system control.

Preferably at least step (b), more preferably steps (b) and (c) can be carried out by a single tray picking handling device. This can increase the efficiency or productivity of the system module. Preferably, the method for operating a system can be defined in such a way that a first and a second stack are alternately provided in the supply zone, and until a stack has been disassembled, the trays of this stack are conveyed alternately either to the first or to the second output station or output zone, with the topmost tray of a first stack (the second tray unit from the top of a stack) is always conveyed to the first output zone and the topmost tray of a second stack (the second tray unit from the top of the stack) is always conveyed to the second output zone. Particularly preferably, the method comprises the transport of a tray cover, which represents the topmost tray unit of each stack, to a transfer station. In the context of the method, it is preferred that stacks of a type I and of a type II are introduced alternately into the supply zone, with the stacks of type I comprising on top a tray covered with a cover from a first production batch A and the stacks of type II comprising on top a tray covered with a cover from a first production batch B.

It is preferred that when operating the system according to the disclosed method, a constant time can be maintained from removing a tray unit from the stack to releasing said tray unit on or at a manipulator of a transfer zone, for example on a tray lift; and/or a time of 180 seconds, more preferably 120 seconds, most preferably 70 seconds is not exceeded. In this way it is possible to maintain a constant time preferably also from the removal of a tray from the stack to the complete emptying of the tray in an output zone and/or preferably not to exceed a time of 180 seconds, more preferably of 120 seconds, particularly preferably 70 of seconds. Thus, high quality standards in the production of contact lenses can be maintained and/or quality loss that contact lenses suffer once they are exposed to the ambient air can be reduced to a minimum.

In the method, it is preferred that a tray unit that is on top of the stack is emptied first by an output handling device and/or the tray unit is released first onto a manipulator of a transfer zone and/or the FIFO principle can preferably be observed for each stack.

In the context of the disclosed method, the tray picking handling device can preferably remove two tray units from a stack and a new stack can be introduced into the supply zone during the time in which at least one of the last two tray units of a stack is at the tray picking handling device. This has the advantage that replacing stacks does not have any negative effect on the system throughput in this process step since, while the last trays are at the output handling device, it is possible to continuously empty trays at the output handling devices, in particular as the tray picking handling device can release the last two trays of the previous stack onto the tray carriage even while the stacks are replaced.

In one step or in a time sequence of the method, a tray carriage preferably simultaneously holds a full tray and an emptied tray, and more preferably, conveys them simultaneously. The method of the invention can preferably be applied in such a way that a lifting unit can move trays from one tray carriage to an output handling device in one or in each output zone, i.e. an output handling device is loaded with a tray by a lifting unit so that the tray carriage or the tray carriages can be moved horizontally while the tray or the trays are emptied by the output handling device(s). This is particularly advantageous in order to direct the trays batchwise to the output handling devices while also observing the FIFO principle and in order to be able to convey the tray cover directly to the transfer zone while trays of the last stack are still at the output handling devices.

The present invention further includes the following aspects:

1. A system comprising a supply zone, at least a first and a second output zone, at least one first waiting zone, at least one transfer zone, at least one tray picking handling device and at least two tray carriages, wherein:
the at least on tray picking handling device is adapted to remove at least two tray units simultaneously from a stack of a plurality of tray units;
the at least one tray picking handling device is further adapted to move the tray units from the supply zone to a first waiting position in the first waiting zone;
each output zone comprises at least one output handling device and at least one lifting unit; and
each transfer zone comprises at least one manipulator.

2. A system comprising a supply zone, at least a first and a second output zone, at least one first waiting zone, at least one transfer zone, at least one tray picking handling device and at least two tray carriages, wherein:
the at least one tray picking handling device is adapted to remove at least one tray unit from a stack of a plurality of tray units;
the at least one tray picking handling device is further adapted to move the at least one tray unit from the supply zone to a first waiting position in the first waiting zone;
each output zone comprises at least one output handling device and at least one lifting unit;
each transfer zone comprises at least one manipulator; and
the tray carriages can be moved on vertically offset paths in a horizontal direction.

3. The system according to any one of aspects 1 or 2, wherein a tray unit is a tray or a tray cover and wherein the at least one tray picking handling device is adapted to move one or more tray units, in particular
i) an even number of trays or
ii) an odd number of trays together with a tray cover.

4. The system of any one of the preceding aspects, wherein the tray picking handling device is adapted to disassemble the stack from top to bottom and/or to remove the topmost tray unit(s) from the stack.

5. The system of any one of the preceding aspects, wherein each tray carriage comprises at least two tray holders, wherein preferably two tray holders of a first tray carriage present a first distance to one another, which corresponds to the distance of the first waiting position to a first lifting unit in the first output zone.

6. The system according to aspect 5, wherein two tray holders of a second tray carriage have a second distance to one another, which corresponds to the distance of a second lifting unit in the second output zone to one of the at least one manipulators.

7. The system of any one of the preceding aspects, wherein at least two, preferably all tray holders of a tray carriage are arranged in the same horizontal plane.

8. The system of any one of the preceding aspects, wherein the first tray carriage and the second tray carriage, preferably all tray carriages have the same geometry.

9. The system of any one of the preceding aspects, wherein the tray picking handling device and/or at least one tray carriage is adapted to receive trays having a tray width and/or a tray length of 200 mm to 800 mm, preferably of 300 mm to 600 mm, particularly preferably of 400 mm to 500 mm.

10. The system of any one of the preceding aspects, wherein the first lifting unit in the first output zone and the second lifting unit in the second output zone have a distance to one another, which corresponds at least to the width or the length of a tray and/or wherein the system comprises a second waiting zone which is arranged between the first and the second output zone.

11. The system of any one of the preceding aspects, wherein the tray carriages can be moved horizontally and the first and/or the second output handling device operate in a horizontal plane, which is vertically offset to a movement plane of at least one tray carriage.

12. The system of any one of aspects 3 to 11, wherein the tray cover can be conveyed by a tray carriage into the transfer zone.

13. The system of any one of aspects 3 to 12, wherein a first stack can be provided in the supply zone and the trays of the first stack are conveyed alternately either to the first or to the second output station.

14. The system of aspect 13, wherein after the first stack has been disassembled, a second stack can be provided in the supply zone and the trays of the second stack are conveyed alternately either to the first or to the second output station with the topmost tray of the second stack being conveyed to the output zone, to which the second tray from the top of the first stack was conveyed.

15. The system of any one of the preceding aspects, wherein a stack comprises at least 4, preferably at least 18, particularly preferably at least 24 tray units and/or comprises a maximum of 80, preferably a maximum of 70, particularly preferably a maximum of 50 tray units.

16. The system of any one of the preceding aspects, wherein a tray unit has a maximum height of 50 mm, preferably of maximum 30 mm, and/or wherein the stack has a maximum height of 1000 mm, preferably of 500 mm.

17. The system of any one of the preceding aspects, wherein a tray unit and/or a stack can be moved in the system in such a way that the tray height and/or the stack height define a vertical direction of the system.

18. The system of any one of the preceding aspects, wherein the tray carriages are offset vertically by at least one tray height, preferably by at least 30 mm, particularly preferably by at least 50 mm, and can be moved horizontally.

19. The system of any one of the preceding aspects, wherein the tray carriage is preferably a linearly movable, particularly preferably horizontally moveable transport device.

20. The system of any one of the preceding aspects, wherein the tray unit which is on top of each stack can be put through the system first.

21. The system of any one of the preceding aspects, wherein the system comprises exactly one transfer zone with at least one manipulator.

22. A method for removing contact lenses from trays, comprising:
i) providing tray units stacked to form a stack, wherein a stack comprises at least two tray units and preferably, the topmost tray unit is a cover and all further trays are individual trays;
ii) simultaneous removal of at least two tray units from the stack;
iii) separate release of the removed tray units onto at least one conveyor element;
iv) removal of contact lenses from individual trays by at least one output handling device.

23. The method of aspect 22, wherein at least step ii), preferably steps ii) and iii) are carried out by a single tray picking handling device.

24. The method of any one of aspects 22 or 23, wherein the at least one conveyor element comprises two tray carriages and wherein a first removed tray unit is released onto a first tray carriage and a second removed tray unit is released onto a second tray carriage.

25. The method of any one of aspects 22 to 24, wherein the method is a method for operating a system of any one of claims 3 to 21.

26. The method of aspect 25, wherein a first and a second stack are provided alternately in the supply zone and, until a stack has been disassembled, the trays of said stack are conveyed alternately either to the first or to the second output station, wherein the topmost tray of a first stack is always conveyed to the first output zone and the topmost tray of a second stack is always conveyed to the second output zone

27. The method of any one of aspects 25 or 26, wherein stacks of types A and B are alternately transferred into the supply zone, wherein a tray covered with a cover from a first production batch is always on top of stacks of type A and a tray covered with a cover from a second production batch is always on top of stacks of type B.

28. The method of any one of aspects 25 to 27, wherein it is possible to maintain a constant time from the removal of a tray unit from the stack until said tray unit is released onto a manipulator of a transfer station and/or not to exceed a time of 180 seconds, preferably 120 seconds, particularly preferably 70 seconds.

29. The method of any one of aspects 25 to 28, wherein it is possible to maintain a constant time from the removal of a tray unit from the stack until the tray is completely emptied in an output zone and/or a time of 180 seconds, preferably 120 seconds, particularly preferably 70 seconds is not exceeded.

30. The method of any one of aspects 25 to 29, wherein a tray unit positioned on top of a stack is also released first on a manipulator of a transfer zone and/or wherein the first-in-first-out principle is observed.

31. The method of any one of aspects 25 to 30, wherein the tray picking handling device removes two tray units from a stack and wherein in the time, during which at least one of the last two tray units of a stack are at the tray picking handling device, a new stack is introduced into the supply zone.

32. The method of any one of aspects 25 to 31, wherein a first tray carriage and a second tray carriage are moved horizontally on a vertically offset path.

33. The method of any one of aspects 25 to 32, wherein a full tray and an empty tray are simultaneously positioned and are moved on a tray carriage.

34. The method of any one of aspects 25 to 33, wherein in each output zone, a lifting unit moves trays from a tray carriage to an output handling device, so that the tray carriage can be moved horizontally while the tray is emptied by the output handling device.

In the following, a preferred embodiment of the invention is described in an exemplary manner with reference to the following Figures. The Figures show:

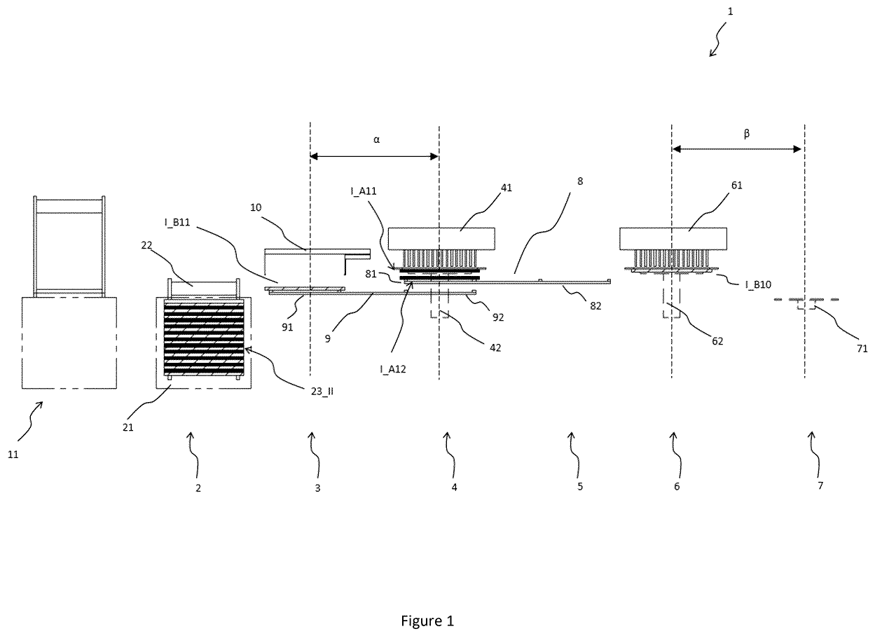

FIG. 1 shows an exemplary schematic representation of a system module of the present invention;

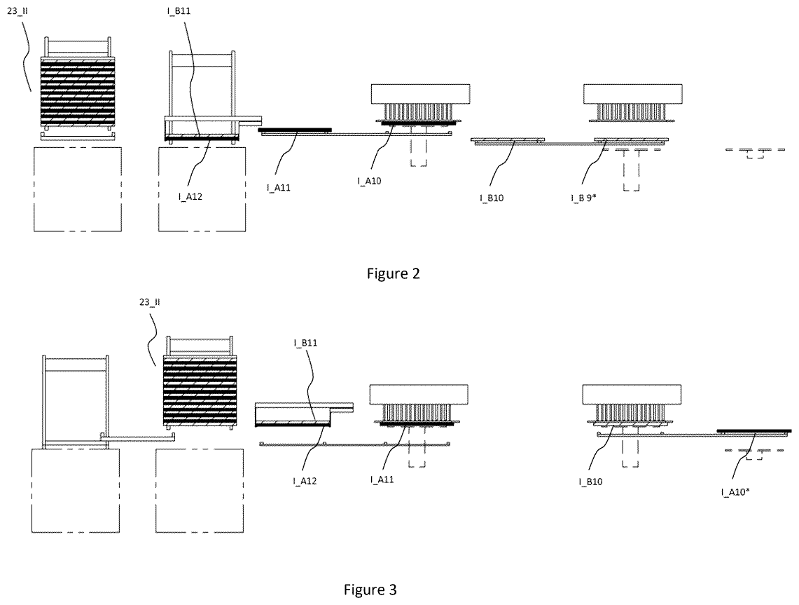

FIG. 2 shows the system module of FIG. 1 at a first operating point;

FIG. 3 shows the system module of FIG. 1 at a second operating point;

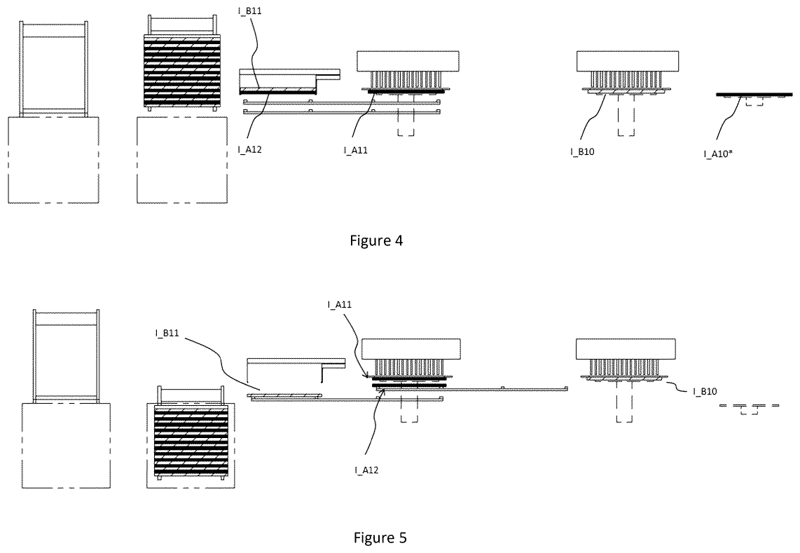

FIG. 4 shows the system module of FIG. 1 at a third operating point;

FIG. 5 shows the system module of FIG. 1 at a fourth operating point, wherein the third operating point corresponds to the operating point at which the system module is represented in FIG. 1;

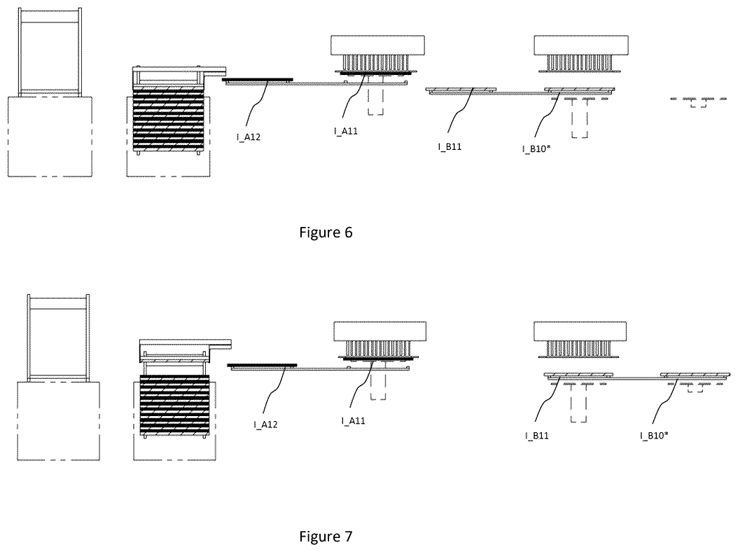

FIG. 6 shows the system module of FIG. 1 at a fifth operating point;

FIG. 7 shows the system module of FIG. 1 at a sixth operating point;

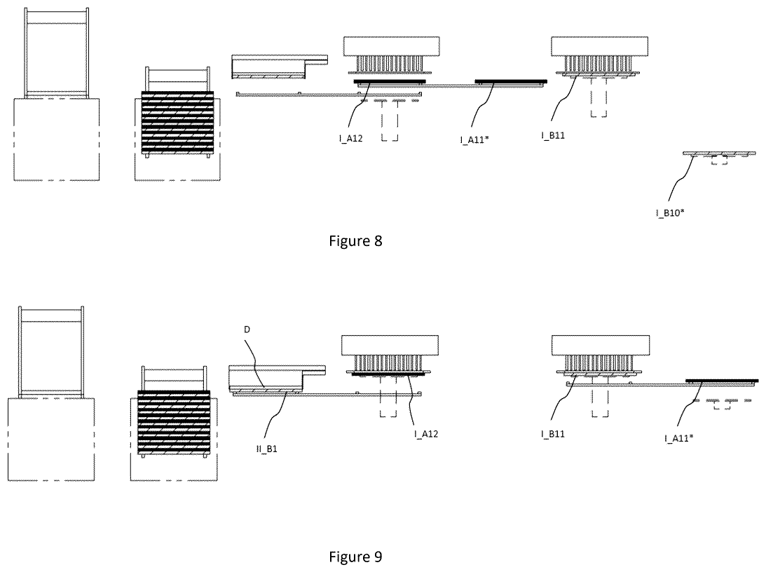

FIG. 8 shows the system module of FIG. 1 at a seventh operating point;

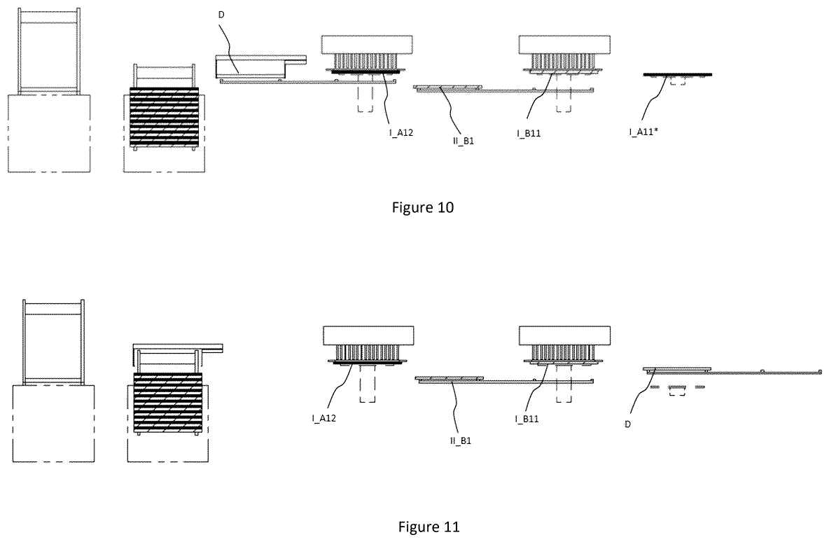

FIG. 9 shows the system module of FIG. 1 at an eighth operating point;

FIG. 10 shows the system module of FIG. 1 at a ninth operating point;

FIG. 11 shows the system module of FIG. 1 at a tenth operating point;

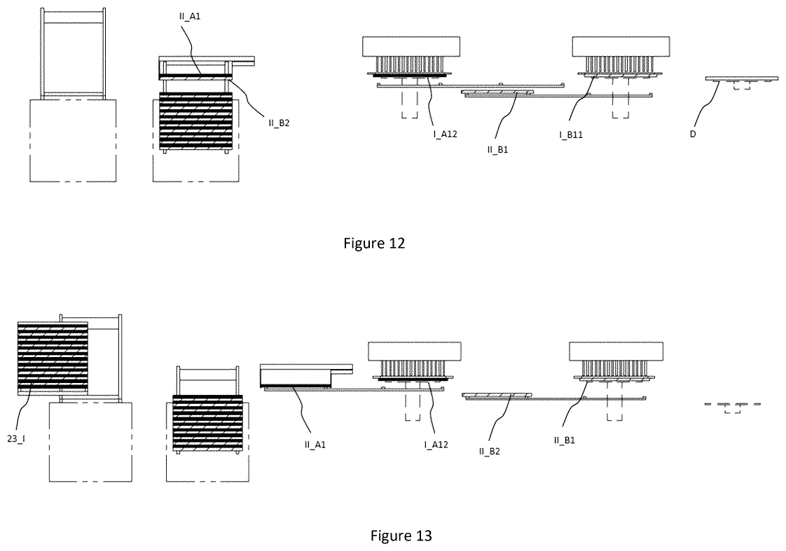

FIG. 12 shows the system module of FIG. 1 at an eleventh operating point;

FIG. 13 shows the system module of FIG. 1 at a twelfth operating point;

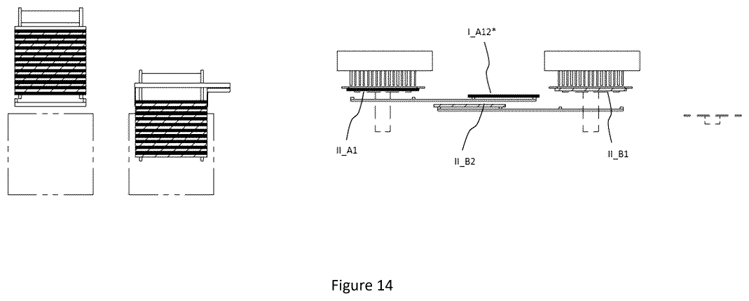

FIG. 14 shows the system module of FIG. 1 at a thirteenth operating point;

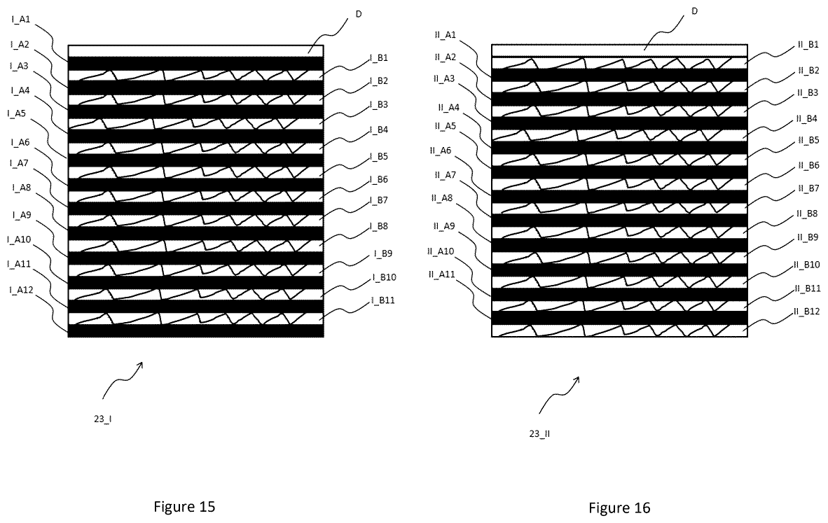

FIG. 15 shows a stack of type I with 23 trays and a tray cover for use in the system module of FIGS. 1-14; and

FIG. 16 shows a stack of type II with 23 trays and a tray cover for use in the system module of FIGS. 1-14.

FIG. 1 is an exemplary schematic representation of the design of a system module 1 of the present invention. In the example shown, system module 1 is directly coupled to a wet chemical process system. One of the wet chemical process tanks 11 is shown in FIG. 1 and is preferably not assigned to system module 1 of the invention. A further tank 21 may be a wet chemical process tank or another tank filled with fluid which is intended to keep the contact lenses moist in said tank and/or protect them from the ambient air. Said tank 21 can define the supply zone of system module 1. A stack lift 22 is disposed in the area of the tank 21 and is adapted to be moved vertically into the tank 21 and out of the tank 21. The stack lift 22 is adapted to receive a stack 23. In the example shown, the stack 23 is formed by a stack of 23 trays A, B and a tray cover D. The structure of the stack 23 of FIG. 1 is explained below in detail in conjunction with FIG. 16. The stack lift 22 is adapted to lower the stack 23 into the tank 21 and to maintain it there and to lift it again out of the tank 21 in multiple intervals, so that a tray picking handling device 10 can pick-up the topmost trays of the stack 23 above the fluid level or above the tank 21, i.e. still in the supply zone 2. At the operating point of the system module shown, the stack 23 is completely located in the tank 21 of the supply zone 2. The system module further comprises a first waiting zone 3, preferably adjacent to the supply zone 2. In addition, the system module comprises a transfer zone 7. A first tray carriage 8 and a second tray carriage 9 can be moved in a horizontal direction between the waiting zone 3 and the transfer zone 7. The first tray carriage 8 comprises a first tray holder 81 (in FIG. 1, the left tray holder of tray carriage 8) and a second tray holder 82 (in FIG. 2, the right tray holder of the tray carriage 8). The second tray carriage 9 also comprises a first tray holder 91 (in FIG. 1, the left tray holder of tray carriage 9) and a second tray holder 92 (in FIG. 2, the right tray holder of the tray carriage 9). Each tray holder 81, 82, 91, 92 of the first and the second tray carriage 8, 9 is adapted for releasing a tray on it. Preferably, a tray holder can be fork-shaped. Preferably, the tray holder can comprise a frame or contact points onto which the tray can be put. It is further preferred that said frame or said fork-shape presents an approximately horizontal U or V on the horizontal plane. Preferably, the frame or the fork-shape is open in a direction perpendicular to the movement direction of the tray carriage. It is further preferred that the tray holder is designed in such a way that a tray located on the tray holder can be removed from the tray holder by lifting it upwards, preferably by means of a lift. Further, a tray holder can preferably comprise a sensor or a mechanical contact which is adapted to detect whether a tray is located on the tray holder. It is further preferred that one or more sensors or mechanical contacts are arranged statically along the movement paths of the tray carriages in the system, preferably in each zone, wherein the sensors or contacts are preferably adapted to detect whether a tray holder is within their detection area and whether said tray holder is free or loaded with a tray.

The two tray carriages 8, 9 of the system module 1 are arranged on different planes and can be moved each horizontally on its respective plane. The two planes are at a distance from each other so that the first tray carriage 8 is on a first movement plane, vertically offset to the second tray carriage 9 on a second movement plane. Thus, the two tray carriages can be moved past each other by moving the first tray carriage 8 above the second tray carriage 9 and the second tray carriage 9 under the first tray carriage 8. The vertical distance of the two tray carriages to each other has to be chosen in such a way that the tray carriages can pass each other when loaded. In the present example, the vertical offset or distance between the two tray carriages is approximately twice the height of a tray. Thus, the system may have a compact structure, yet the tray carriages still have enough safety clearance between them so that the system can be operated reliably.

At the operating point of the system shown in FIG. 1, it can be seen that the tray picking handling device 10 as well as the first tray holder 91 of the second tray carriage 9 are located in the first waiting zone. The tray picking handling device 10 is open and thus empty. Thus, it does not hold or convey a tray unit at the operating point shown. However, a tray unit I_B from a batch B is positioned on the tray holder 91.

A first output zone 4 is arranged adjacent to the first waiting zone 3. The first output zone 4 comprises a first output handling device 41 and a first lifting unit 42. At the operating point shown, the lifting unit 42 is activated, i.e. moved upwards so that the output handling device 41 is loaded with a tray I_A from a batch A. This implies that a tray I_A is so close under the output handling device 41 that the output handling device 41 can empty the tray I_A, i.e. can remove the individual contact lenses from tray I_A. Preferably, the output handling device 41 comprises one or more suction devices, wherein each suction device can aspirate one contact lens and thus remove it from tray I_A. More preferably, the output handling device 41 comprises as many suction devices as there are wells in a row of a tray so that only as many aspiration processes as the tray has rows are required to empty the whole tray. It is particularly preferred that the output handling device 41 comprises as many suction devices as there are wells on the tray so that it is possible to empty the whole tray in one aspiration process. The lifting unit 42 preferably comprises a tray lifter which preferably can remove a tray from a tray holder of a tray carriage, preferably by lifting it upwards. More preferably, the lifting unit 42 with the tray lifter can be moved in such a way that the tray lifter can at least assume two positions. In a first “active” position, the tray lifter of the lifting unit 41 is above the first movement plane of the first tray carriage 8, in a second “not active” position, the tray lifter of the lifting unit 41 is below the second movement plane of the second tray carriage 9. For this reason, both tray carriages 8, 9 can be moved if the tray lifter is in one of the positions “active” or “not active”. This is advantageous in order to put the trays through the system module in a time-efficient manner, in accordance with individual batches and/or in accordance with the FIFO principle and/or to reduce the susceptibility to interference of the system module.

A second output zone 6 comprises a second output handling device 61 and a second lifting unit 62. Preferably, the second output handling device 61 has the same features as the first output handling device 41, more preferably both output handling devices are of the identical design. The second lifting unit 62 preferably comprises the same features as the first lifting unit 42, more preferably, both lifting units are of identical design. At the operating point of the system module 1 shown in FIG. 1, the second lifting unit 62 is activated, i.e. the tray lifter of the second lifting unit 62 is raised so that a tray I_B can be emptied by the output handling device 61 and additionally, the movement path of the first tray carriage 8 is not blocked by the lifting unit 62.

In the embodiment shown, the first output zone 4 and the second output zone 6 are arranged at a distance from each other so that a second waiting zone 5 can be defined between the two output zones 4 and 6. The particular purpose of said waiting zone is that the first output handling device 41 can be loaded with a tray of batch A of the first tray holder 81 of the first tray carriage 8 and simultaneously or as long as the first tray carriage 8 is at this position (with the first tray holder 81 in the first output zone 4 as shown in FIG. 1), the second output handling device 61 can be loaded with a tray of batch B of one of the tray holder of the second tray carriage 9. Thus, it is preferred that the distance between the two output handlings and consequently, the dimension of the area of the second waiting area 5 is chosen such that the second tray holder 82 at the position described does not interfere with the loading of the second output handling device 61. Such a design can allow for a system control with a simpler design, in particular, as it is not necessary during operation to verify whether an output handling device or a lifting unit is blocked by a tray carriage located at a predefined position (e.g. in an output zone).

In the system shown, the transfer zone 7 is adjacent to the second output zone 6. The transfer zone 7 can be defined by a manipulator which is adapted for the transfer of emptied trays to an adjacent system module, an adjacent system or further manual processing. The embodiment shown in FIG. 1 comprises a manipulator. In the embodiment shown, the manipulator is a tray lift 71 which preferably comprises a tray lifter adapted to lift a tray out of a tray holder of a tray carriage. Thus, by using the tray lift 71, it is possible to convey a tray located in the transfer zone 7 upwards or downwards in a vertical direction. In other embodiments, the manipulator can also be a carriage or a multi-axis manipulator which is designed in such a way that it is adapted to convey a tray further.

The design and the distance of the two tray holders 81, 82 and 91, 92, respectively, of a tray carriage 8, 9 with respect to one another and thus the width of a tray carriage depends on the dimensions of the trays on the one hand and of individual system components on the other hand. Preferably, on each carriage, two tray holders are arranged on said tray carriage in such a way that the tray carriage can be loaded with two trays at the same time. In addition, it is preferred that the first tray carriage 8 is designed in such a way that the first tray holder 81 can be loaded in the waiting zone 3 by means of a tray picking handling device with a first tray of a batch, e.g. batch A, and at the same time the first lifting unit 42 can remove a second tray of the same batch (in this case batch A) from the second tray holder 82 or release it onto the second tray holder 82 and thus the first output handling device 41 can be loaded or emptied. FIG. 1 shows a preferred distance α which refers to both, the distance of the two tray holders 81, 82 of the first tray carriage and the distance of the lifting unit 42 to the tray picking handling device 10 in the first waiting zone 3 (as measured from the center axis to the center axis in each case). Furthermore, it is preferred that the second tray carriage 9 is designed in such a way that the second lifting unit 62 can remove a first tray of a different batch, e.g. batch B, from the first tray holder 91 or release it onto the first tray holder 91 and thus can load or empty the second output handling device 61 and the tray lift 71 can at the same time remove a second tray of the same batch (in this case batch B) from the second tray holder 92 of the second tray carriage 9 and convey it further. FIG. 1 shows a preferred distance β which refers to both the distance of the two tray holders 91, 92 of the second tray carriage 9 and the distance of the lifting unit 62 to the tray lift 71 (as measured from the center axis to the center axis in each case). It is further preferred that the first and the second tray carriage have the same width and/or the tray holders of the first and the second tray carriage have the same distance to one another. In the embodiment shown, this results in the distance α (between the center axis of the tray picking handling device 10 in the first waiting position 3 and the center axis of the lifting unit 42) corresponding to distance β (between the center axis of the lifting unit 62 and the center axis of the tray lift 71).

The system module shown in FIG. 1 extends horizontally, that is, the individual zones are defined in the horizontal direction. However, this is not to limit the inventive concept. A system or a system module according to an embodiment of an aspect of the invention can also extend in a different direction, in particular in vertical direction. With a vertical system design, the tray carriages could consequently be moved vertically, and the movement paths of the tray carriages could be defined horizontally offset to each other. As a rule, horizontal system construction is to be preferred since such a system design can be carried out more cost-effectively. Constraints of the premises, e.g. due to columns, storage rooms or other systems in the manufacturing facilities may necessitate that at least not all zones of the system module may be provided on the same horizontal plane.

Preferably, the system module 1 can put through trays which are introduced in stacks into the supply zone 2, with the stack comprising trays from two batches A and B, which are always arranged alternately in the stack as shown in FIGS. 15 and 16. FIGS. 15 and 16 each show a stack 23 of a type I or II. Consequently, the stacks are referred to as 23_I and 23_II, respectively. Each stack comprises 24 tray units, with one tray unit being a tray cover. Thus, the stacks which each are composed of trays from two batches comprise different numbers of trays of a batch, which is why the stacks can be classified into two types, I and II.

Stack 23_I is shown in FIG. 15 and comprises 12 trays of batch A, 11 trays of batch B and one tray cover D. The bottom tray of stack 23_I is a tray of batch A (tray I_A12, shown shaded). Above said tray, a tray of batch B (tray I_B11, shown hatched) is arranged. Stack 23_I is arranged in such a way that trays of batch A and of batch B are always stacked alternately. Thus, the topmost tray (the second tray unit from top) is again a tray of batch A (tray I_A1, shown shaded). On top of said tray is the tray cover D (topmost tray unit). The latter is arranged on top of the stack to prevent the contact lenses in the tray below from floating. The positions of the tray units can be numbered consecutively from bottom to top with numbers 1 to 24. In stack 23_I, trays of batch A are at positions 1, 3, 5, 7, 9, 11, 13, 15, 17, 19, 21, 23, trays of batch B at positions 2, 4, 6, 8, 10, 12, 14, 16, 18, 20, 22 and a tray cover at position 24. To satisfy the FIFO principle, the stack should be disassembled from top to bottom, i.e. the tray of position 23 should be put through the system module first, followed by the tray of position 22, etc. For this reason, the individual trays are numbered separately according to their respective batches from top to bottom in FIG. 15.

Stack 23_II is shown in FIG. 16 and comprises 11 trays of batch A, 12 trays of batch B and a tray cover D. The bottom tray of stack 23_II is a tray of batch B (tray II_B12, shown hatched). On top of it, a tray of batch A (tray II_A11, shown shaded) is arranged. Stack 23_II is arranged in such a way that trays of batch A and of batch B are always stacked alternately. Consequently, the topmost tray (second tray unit from the top) is again a tray of batch B (tray I_A1, shown hatched). On top of said tray is the tray cover D (topmost tray unit). The latter is arranged on top of the stack to cover the trays below and protect them against particles from above. The positions of the tray units can be numbered consecutively from bottom to top with numbers 1 to 24 as in FIG. 15. However, in stack 23_II, trays of batch B are at positions 1, 3, 5, 7, 9, 11, 13, 15, 17, 19, 21, 23, trays of batch A at positions 2, 4, 6, 8, 10, 12, 14, 16, 18, 20, 22 and a tray cover at position 24. To satisfy the FIFO principle, the stack of type II is also to be disassembled from top to bottom, i.e. the tray of position 23 should be put through the system module first, followed by the tray of position 22, etc. For this reason, the individual trays are numbered separately according to their respective batches from top to bottom also in FIG. 16.

In other words, the stacks of each type I or II consist of 24 tray units, with the top tray unit being a tray cover D, the second tray unit from the top is the topmost tray and the bottom tray unit is the bottommost tray. The bottommost tray unit and the second unit, in other words the bottommost and the topmost tray are trays from the same batch. Between these, trays from the same batch as the bottommost tray or the bottom tray unit and trays from another or second batch are stacked alternately.

FIG. 1 shows a snapshot of the system module 1 of the invention in operation. At the operating point shown, a new stack 23_II of type II with 24 tray units is in the supply zone 2. As described above, these 24 tray units include a total of 23 trays and a tray cover. The bottom tray of stack 23 is a tray of batch B (shown hatched). On top of said tray, a tray of batch A (shown shaded) is arranged. The topmost tray (second tray unit from the top) is again a tray of batch B (shown hatched). On top of it, the tray cover is arranged (topmost tray unit). In FIG. 1, the stack 23_II of type II is located completely within the tank 21 of the supply zone 2. In zones 3 to 7 of system 1, trays originating from a stack 23_I of type I, which was in supply zone 2 prior to stack 23_II, are still moved and emptied. Said stack 23_I was already disassembled in the preceding process steps (thus, stack 23_I is no longer present in the snapshot of FIG. 1) and it was made up according to the stack shown in FIG. 15. Since stack 23_I was disassembled from top to bottom and the trays are put through in the system module 1 according to the FIFO principle, trays I_A11, I_B10, which are at the output handling devices 41, 61, are the trays of positions 3, 4 of stack 23_I and trays I_A12, I_B11, which are on the tray holders 81, 91 of tray carriages 8, 9, are the trays from positions 1 and 2 of stack 23_1.

In the following, the functions of the system module will be explained together with the method of the invention for operating the system module in individual snapshots or process steps using FIGS. 2 to 14. In this context, FIG. 5 shows the operating point of the system already used in FIG. 1 to explain the system components. FIGS. 2 to 4 show three process steps which precede the snapshots shown in FIGS. 1 and 5, respectively, so that FIGS. 2 to 4 illustrate how trays A, B arrive at the positions at which they are in the snapshot of FIGS. 1 to 10, respectively. The further FIGS. 6 to 14 show snapshots illustrating the transfer of the trays through the system module 1. For better orientation, the tray references in the Figures comprise an identification for the stack from which they originate (Roman numeral), the batch from which they originate (A, B) and their number, with which they are also numbered from top to bottom in the stacks in FIGS. 15 and 16. Trays that already passed an output handling device and were emptied there are additionally marked with an asterisk *. In FIG. 2, stack 23_II known from FIG. 1 is not yet in the supply zone 2. In fact, the supply zone 2 still contains stack 23_1, which is almost completely disassembled. However, stack 23_I. has already been lifted out of the tank to such a degree that the tray picking handling device 10 was already able to pick up the last two trays of stack 23_I. In FIG. 2, a tray I_B11 and a tray I_A12 are at the tray picking handling device 10, with tray I_B11 being arranged above tray I_A12 (i.e. in the same order as the trays were arranged on stack 23_I). It is necessary to follow the order of the trays in stack 23_I from top to bottom when emptying the trays. In other words, with respect to the trays, the FIFO principle is to be observed in system module 1. Consequently, it is required that the upper tray I_B11 is first emptied by the tray picking handling device 10 in an output zone and that only subsequently, the lower tray I_A12 is emptied by the tray picking handling device in an output zone. For this reason, not only two output handling devices 41, 61 are used in the system shown, which, —in comparison with the use of one output handling device, would allow doubling the removal quantity of contact lenses with the same cycle time and unchanged tray size, but the system module 1 shown comprises additionally two tray carriages 8, 9, each with two tray holders 81, 82 and 91, 92, respectively, wherein the tray carriages 8, 9 can move past each other so that the system module 1 can sort the trays to the tray picking handling devices 41, 61 batchwise and transport the trays according to the FIFO principle at the same time.

In FIG. 2, a tray I_A10 is at the output handling device 41. Tray I_A10 is emptied at the device. Another, full tray I_A11 is positioned on the tray holder 81 of the first tray carriage 8 in the first waiting zone 3. On the second tray carriage 9, a full tray I_B10 is on the tray holder 91 in the second waiting zone 5 and an emptied tray I_B9* in the second output zone on the tray holder 92. The tray carriage 9 is then moved one position to the right so that the tray carriage 9 is at a position at which both the emptied tray I_B9* can be picked up by the tray lift 71 and the full tray I_B10 can be conveyed to the output handling device 61 using the lifting unit 62 (not shown). Thus, the trays can be unloaded from the second tray carriage 9 so that, subsequently, there are no trays left on the tray carriage 9. The tray carriage 9 can receive new trays and is moved to the first waiting zone 3 for this purpose (see FIG. 3). Subsequently, the tray carriage 8 will receive the emptied tray I_A10* from the output handling device 41 by means of the tray holder 82, then be moved one position to the right so that the lifting unit 42 can remove the full tray I_A11 from the tray holder 81 and convey it to the output handling device 41. Subsequently, the first tray carriage 8, loaded with only one empty tray I_A10* on the tray holder 82, will be moved to the waiting zone 7 so that the empty tray I_A10* can be picked up by the tray lift 71 and can be transferred to an adjacent module. Said process step is shown in FIG. 3 (with tray carriage 9 in the first waiting zone 3). Once the empty tray I_A10* has been picked up by the tray lift 71, there are no trays left on the first tray carriage 8 either, thus, the tray carriage is available and can be moved into the first waiting zone 3.

In FIG. 4, both tray carriages 8, 9 are in the first waiting zone 3. Tray I_A12 can be released onto the first tray carriage 8 by the tray picking handling device 10, subsequently, the first tray carriage 8 can be moved a position to the right so that tray I_B11 can also be released onto the second tray carriage 9 by the tray picking handling device 10. This state is shown in FIG. 5 and corresponds to the process step that is also shown in FIG. 1, used to explain the system module. As can be seen, the time during which the process steps described in the context of FIGS. 2 to 4 are carried out, is sufficient to introduce a new stack 23 with trays into the supply zone, after a stack 23_I has been completely disassembled in the supply zone, since the tray picking handling device 10 loaded with the last two trays I_A12 and I_B11 of stack 23_I can remain in the first waiting zone and can transfer the trays to the tray carriages, while the two tray carriages 8, 9 move the trays through the system module 1 and provide the output handling devices 41, 61 with trays.

In FIG. 5, the full trays I_A12, I_B11 are on the respective left tray holder 81, 91 of the first and the second tray carriage 8, 9. Furthermore, each output handling device 41, 61 contains a tray I_A11 and I_B10, respectively, which are emptied. Subsequent to the snapshot shown in FIG. 5, further process steps take place which are shown in FIGS. 6 to 14 and which illustrate how the trays of the new stack 23 are distributed to the output handling devices 41, 61, on the one hand, and how, on the other hand, the tray cover D of stack 23 is transferred through the system module 1 without interrupting the emptying processes in the output handling devices 41, 61. In FIG. 6, the first tray carriage 8 is moved back again into the first waiting position 3 so that it is possible to release a tray I_A11*, which was emptied by the output handling device 41, using the lifting unit 41 onto the free, second tray holder 82 of the first tray carriage 8. The second tray carriage 9 is moved to the third position so that the full tray I_B11 positioned on the tray holder 91 of the second tray carriage 9 is in the second waiting zone 5 and the second tray holder 92 is in the second output zone 6, so that a tray I_B10* emptied by the output handling device 61 can be released onto the free, second tray holder 92 of the second tray carriage 9 using the lifting unit 61.

In FIG. 7, the second tray carriage is moved again one position to the right so that the tray lift 71 in the transfer zone 7 can pick up the empty tray I_B10* from the second tray holder 92 of the second tray carriage 9 and the lifting unit 61 can remove the full tray I_B11 from the first tray holder 91 of the second tray carriage 9 and transfer it to the output handling device 61 (this position was already accessed by the second tray carriage in the processes described before in the snapshots shown in FIG. 2 and FIG. 3). Furthermore, it can be taken from FIG. 7 that the tray picking handling device 10 has already picked up the two topmost tray units, i.e. a tray cover D and beneath it a tray II_B1 of batch b from stack 23 in the supply zone 2.

FIG. 8 shows that tray I_A11*, which was emptied before at the output handling device 41 is now on the second tray holder 82 of the first tray carriage 8 and the first tray carriage 8 was moved one position to the right so that a full tray I_A12 is in the first output zone 4. The second tray carriage 9 is free in FIG. 8, i.e. it is empty since the two trays I_B11 and I_B10*, which were still on the second tray carriage 9 in FIG. 7, were removed by the tray lift 71 and by the lifting unit 61, respectively, from the tray carriage 9. The second, free tray carriage 9 is back again in the first waiting zone 3, as is the tray picking handling device 10, which is loaded with two tray units as described above.

FIG. 9 shows that the tray picking handling device 10 releases tray II_B1 (which is at the bottom at the tray picking handling device 10) onto the second tray carriage 9. The full tray I_A12 on the first tray holder 81 was already removed by the lifting unit 42 from the first tray carriage 8 so that it can now be emptied by the output handling device 41. In the process step shown in FIG. 9, the first tray carriage 8 with the second tray holder 82 is in the transfer zone 7 so that tray lift 71 can remove the emptied tray I_A11* from the second tray holder 82.

FIG. 10 shows the emptied tray I_A11* on the tray lift 71 in the transfer zone 7. The first tray carriage 8 is back in the first waiting position so that the tray picking handling device 10 can release the tray cover D onto the first tray holder 81 of the first tray carriage 8. The second tray carriage 9 is loaded with a full tray II_B1 on the first tray holder 91 and is positioned such that the second tray holder 92 is in the second output zone 6.

FIG. 11 shows the first tray carriage 8 in such a position that the first tray holder 81 is in the transfer zone 7. The first tray carriage 8 could be moved directly at this position without having to stop at an output zone 4, 6 since both lifting units 42, 62 are at their upper position and thus, do not block the movement path of the first tray carriage 8. This also enables both trays I_A12 and I_B11, which are at the output handling devices 41, 61, to be emptied continuously, even though the cover D was transferred to the transfer zone 7. At the position of the first tray carriage 8 shown in FIG. 11, the tray cover D located on the first tray holder 81 can be picked up by the tray lift 71. At this position, the first tray carriage 8 is furthest to the right in the entire process. This is why said position is limiting for the longitudinal dimensions of system module 1.

FIG. 12 shows the tray cover D on the tray lift 71 in the transfer zone 7. The first tray carriage 8 is positioned in such a way that the second output zone 6 is not blocked by the first tray carriage 8. In the embodiment shown, the first tray holder 81 of the first tray carriage is in the first output zone 4 and consequently, the second tray holder 82 is positioned in the second waiting zone 5. Due to the fact that a second waiting zone 5 is provided in the system 1, the first tray carriage can be positioned in such a way that it is neither in the second output zone 6 nor in the first waiting zone 2. This has the advantage that the first tray carriage does not have to be moved in the following process steps. That is, in the following steps, first the emptied tray I_B11* is released on the second tray holder 92 of the second tray carriage 9. Subsequently, the second tray carriage 9 is moved a position to the right so that the second tray holder 92 is positioned in the transfer zone 7 and the first tray holder 91 is positioned in the second output zone 6. The tray lift 71 can then remove the emptied tray I_B11* from the second tray holder 92 and the lifting unit 62 can remove the full tray II_B1 from the first tray holder 91 and load it onto the output handling device 61. Thus, the FIFO principle is observed and the second tray carriage 9 is available and can be moved into the first waiting zone to be loaded with a new tray II_B2. From FIG. 12 it is clear that the tray picking handling device 10 has already removed two tray units from stack 23, with the tray picking handling device 10 containing a tray II_B2 of batch B at the bottom and only on top of said tray a tray II_A1 of batch A. Since in the earlier processes, trays of batch B (i.e. trays which are emptied at the second output zone 6) were conveyed with the second tray carriage, the system control can be designed to be significantly simpler and thus less prone to errors or faults if the trays from batch B continue to be moved with the second tray carriage. For this reason, it is advantageous to first position the free second tray carriage 9 in the first waiting zone in order to pick up the lower tray II_B2 from the tray picking handling device 10 and only then move the first tray carriage 8 into the first transfer zone to pick up the second tray II_A1 from the tray picking handling device 10.

In FIG. 13, it can be seen that the second tray carriage 9, already loaded with the full tray II_B2 on the first tray holder 91 is positioned with the second tray holder 92 in the second output zone 6 in order to again pick up tray II_B1 from the output handling device 61 as soon as it has been emptied. The first tray carriage 8 is located with the first tray holder 81 in the first waiting zone 3, in order to pick up tray II_A1 from the tray picking handling device 10 and at the same time, the second tray holder 82 is located in the first output zone 4, so that the emptied tray I_A12* can be picked up from the output handling device 41.

In a subsequent process step, which is shown in FIG. 14, no change can be noticed in output zone 6 and the second tray carriage 9 is still at the same position as in FIG. 13 (waiting position to pick up tray II_B1 as soon as it is empty). In contrast, in the first output zone 4, the empty tray I_A12* was released on the second tray holder 82 of the first tray carriage 8, the tray carriage 8 was moved one position to the right and a full tray II_A1 was removed from the first tray holder 81 of the first tray carriage 8, so that the first output handling device 41 is again loaded with a tray. It is advantageous—taking into account the FIFO principle—to load the first output handling device with a new tray before the emptied tray is conveyed from the first output handling device to the transfer zone 7, as this ensures that the tray changing time or loading time at the first output handling is as short as possible, thus increasing the productivity and/or efficiency of the system module. In addition, the second waiting zone 5 proves to be advantageous in the process step shown, since the second output zone 6 is not blocked by the first tray carriage 8. Consequently, the two output zones can be loaded and unloaded independently of each other, and further interlocks in the control system, i.e. physically blocking an output station, or more precisely an output handling device of an output station or output zone depending on the process cycle, can be omitted. This is particularly advantageous in terms of the cycle time that can be achieved, of operational reliability and minimal susceptibility to failure and malfunctions of the system. Nevertheless, there may be applications where it might be preferable not to provide a second waiting zone. In accordance with the FIFO principle, the emptied tray I_A12* is conveyed to the transfer zone before tray II_B1 from the second output handling 61 is emptied and can be released back on the second tray carriage. Thus, a second waiting zone is not always necessary for the operating process. In applications, for example, in which the shortest possible length of the system structure is a high priority and a correspondingly more complex control system can be accepted, the second waiting zone 5 can be dispensed with, provided that the control system locks the physically blocked modules in order to ensure smooth operation.

The system shown, operated with a control system that controls the system according to the described process sequence and/or the method according to the invention, is configured to alternately put through stacks having a structure as shown in FIGS. 14 and 15. The system according to the invention can also be operated with a control system that controls a different process sequence. The individual zones and handling devices of the system are adapted for a variety of possible control systems to put through trays from a stack in accordance with the FIFO principle and separately in two batches. Tray covers covering a stack, on the other hand, are conveyed through the system module without accounting for batches or observing the FIFO principle.

1. A system with a supply zone, a first output zone, a second output zone, a first waiting zone, at least one transfer zone, at least one tray picking handling device and at least two tray carriages, wherein:
the at least one tray picking handling device is adapted to remove at least two tray units from a stack of a plurality of tray units at the same time;
the at least one tray picking handling device is further adapted to move the tray units from the supply zone to a first waiting position in the first waiting zone;
each output zone comprises at least one output handling device and at least one lifting unit; and
each transfer zone comprises at least one manipulator.

2. A system with a supply zone, a first output zone, a second output zone, a first waiting zone, at least one transfer zone, at least one tray picking handling device and at least two tray carriages, wherein:
the at least one tray picking handling device is adapted to remove at least one tray unit from a stack of a plurality of tray units;
the at least one tray picking handling device is further adapted to move the at least one tray unit from the supply zone to a first waiting position in the first waiting zone;
each output zone comprises at least one output handling device and at least one lifting unit;
each transfer zone comprises at least one manipulator; and
the tray carriages can be moved on vertically offset paths in horizontal direction.

3. The system according to claim 1, wherein a tray unit is a tray or a tray cover and wherein the at least one tray picking handling device is adapted to move one or more tray units.

4. The system according to claim 1, wherein the tray picking handling device is adapted to disassemble the stack from top to bottom and/or to remove a topmost tray unit(s) from the stack.

5. The system according to claim 1, wherein each tray carriage has at least two tray holders.

6. The system according to claim 1, wherein the tray picking handling device and/or at least one tray carriage are adapted to receive trays with a tray width and/or a tray length of 200 mm to 800 mm.

7. The system according to claim 1, wherein the at least one lifting unit comprises a first lifting unit in the first output zone and a second lifting unit in the second output zone, wherein the first lifting unit in the first output zone and the second lifting unit in the second output zone have a distance from one another corresponding at least to the width or the length of a tray and/or wherein the system has a second waiting zone which is arranged between the first output zone and the second output zone.

8. The system according to claim 1, wherein the at least one output handling device comprises a first output handling device and a second output handling device, wherein the tray carriages can be moved horizontally and the first and/or the second output handling device operate in a horizontal plane which is vertically offset from a movement plane of at least one tray carriage.

9. The system according to claim 3, wherein the tray cover can be conveyed by a tray carriage into the at least one transfer zone.

10. The system according to claim 3, wherein a first stack can be provided in the supply zone and the trays of the first stack are conveyed alternately either to the first or to the second output zone.

11. The system according to claim 10, wherein, after the first stack has been disassembled, a second stack can be provided in the supply zone and the trays of the second stack are conveyed alternately either to the first or to the second output zone, wherein the topmost tray of the second stack is conveyed to the output zone to which the second tray from the top of the first stack was conveyed.

12. The system according to claim 1, wherein the tray carriages are vertically offset by at least one tray height.

13. The system according to claim 1, wherein the tray unit, which is located at a top of each stack, can be put through the system first.

14. A method for removing contact lenses from trays, comprising:
(a) providing tray units stacked to form a stack, wherein a stack comprises at least two tray units;
(b) simultaneous removal of at least two tray units from the stack;
(c) separate release of the removed tray units onto at least one conveyor element;
(d) removal of contact lenses from individual trays by means of at least one output handling device.

15. The method according to claim 14, wherein at least step (b) is carried out by a single tray removal handling device.

16. The method according to claim 14, wherein the at least one conveyor element comprises two tray carriages and wherein a first removed tray unit is released on a first tray carriage and a second removed tray unit is placed on a second tray carriage.

17. The method according to claim 14, wherein the method is a method for operating a system with a supply zone, at least a first and a second output zone, at least a first waiting zone, at least one transfer zone, at least one tray picking handling device and at least two tray carriages, wherein:
the at least one tray picking handling device is adapted to remove at least two tray units from a stack of a plurality of tray units at the same time;
the at least one tray picking handling device is further adapted to move the tray units from the supply zone to a first waiting position in the first waiting zone;
each output zone comprises at least one output handling device and at least one lifting unit; and
each transfer zone comprises at least one manipulator.

18. The method according to claim 17, wherein a first and a second stack are alternately provided in the supply zone, and, until a stack is disassembled, the trays of this stack are alternately conveyed to either the first or the second output zone, wherein the topmost tray of a first stack is always conveyed to the first output zone and the topmost tray of a second stack is always conveyed to the second output zone.

19. The method according to claim 14, wherein a constant time can be maintained from the removal of a tray unit from the stack to the positioning of said tray unit on a manipulator of a transfer station and/or a time of 180 seconds is not exceeded.

20. The method according to claim 14, wherein a constant time can be maintained from the removal of a tray from the stack until the tray is completely emptied in an output zone and/or a time of 180 seconds is not exceeded.

21. The method according to claim 14, wherein a tray unit lying on top of the stack is also positioned first on a manipulator of a transfer zone and/or wherein a first-in-first-out principle is observed with respect to the trays.

22. The method according to claim 14, wherein the tray removal handling device removes two tray units from a stack and wherein, during the time in which at least one of the last two tray units of a stack are at the tray removal handling device, a new stack is introduced into the supply zone.

23. The method according to claim 14, wherein a first tray carriage and a second tray carriage are moved horizontally on vertically offset paths.

24. The method according to claim 14, wherein a full tray and an empty tray are positioned and moved simultaneously on a tray carriage.
